(19) United States
(12) Patent Application Publication
(10) Pub. No.: US 2007/0236040 A1
(43) Pub. Date: Oct. 11, 2007

(54) Blind me not

(76) Inventor: Anthony Vincent White, Sacramento, CA (US)

Correspondence Address: Anthony V. White, 8698 Elk Grove Blvd. #3, PMB 112, Elk Grove, CA, 95624, US

(21) Appl. No.: 11/398,070

(22) Filed: Apr. 6, 2006

(51) Int. Cl. B60J 3/02

(52) U.S. Cl. 296/97.8

(57) ABSTRACT

This invention is an attachable/detachable, clip on, horizontal automoble sun visor extension which slides open or slides to close. It is simple, yet, when I went to purchase one, I was told that they didn't exist.

### BACKGROUND OF THE INVENTION

This invention pertains to clip on, automobile sun visors. It solves the problem of automobile sun visors being too short (horizontally) to fully block blinding sun.

### BRIEF SUMMARY OF THE INVENTION

This invention is designed to clip to the side of a sun visor in an automobile and slide horizontally to block out blinding sunlight. This invention is made from hard plastic with two metal clips to attach it to the side of the visor.

### BRIEF DESCRIPTION OF THE SEVERAL VIEWS OF THE DRAWING

FIG. 1 This is a frontal view of the “Blind Me Not” in the “closed” position. Reference “A” points to the hard plastic outer shell of the device. It measures 6″×4.″ Reference letter “B” points to the flat, plastic visor iside of, and slightly protruding out of, the outer plastic shell. It is 3¾″ tall by 6″ wide by ⅛″ thick. To open, the visor simply slides horizontally, acting as an extension to an existing automobile sun visor. Reference “C.” indicates small plastic bumps attached to, and part of the hard plastic internal visor. These are to keep the visor sticking out far enough to grasp when extending. Reference “D” simply shows an attached mirror. The entire “Blind Me Not” device may be used on either the passenger or drivers side sun visor by simply inverting it, in which case the top would become the bottom, the bottom the top, the left becomes the right, and the right becomes the left side.

FIG. 2 This is the back view of the “Blind Me Not” in the closed position. Reference letter “A” again shows the outer plastic shell. Reference “B” shows the internal extendible visor from the back. Reference “E” shows the two metal clips which allows the “Blind Me Not” to be attached or “clipped on” to an existing automobile sun visor.

FIG. 3 This is the frontal view with the visor fully extended. Reference “F” is a seam in the shell.

FIG. 4 This shows the side view that the visor extends from.

FIG. 5 This shows the side view that the visor does not extend from.

FIG. 6 This shows a top view if the device were to be attached to the drivers side existing automobile sun visor. This is a fully extended view.

FIG. 7 This again is a top view, but in the closed position.

FIG. 8 This is a closed bottom view.

FIG. 9 This is a view of the horizontally sliding visor without the shell.

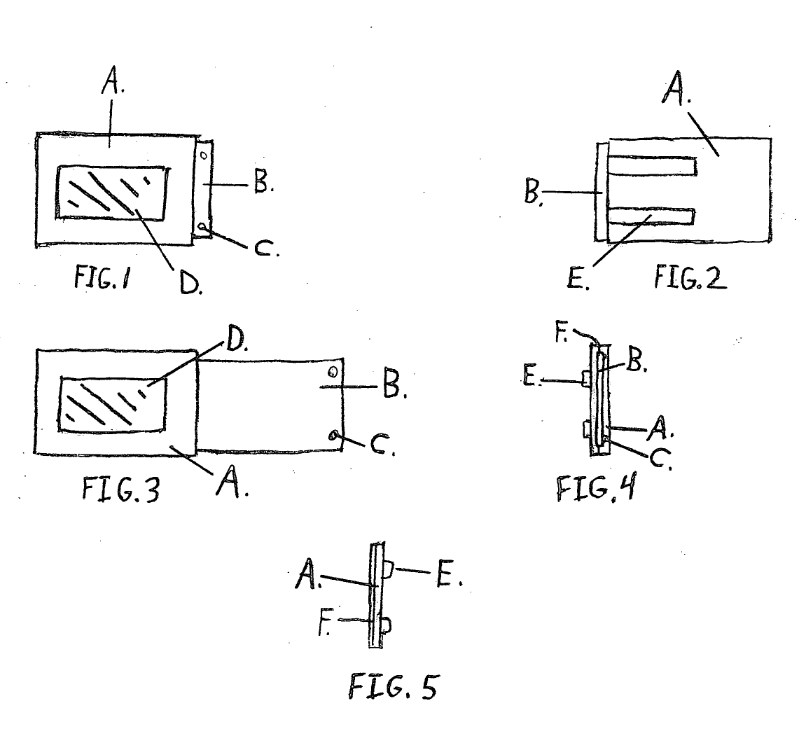

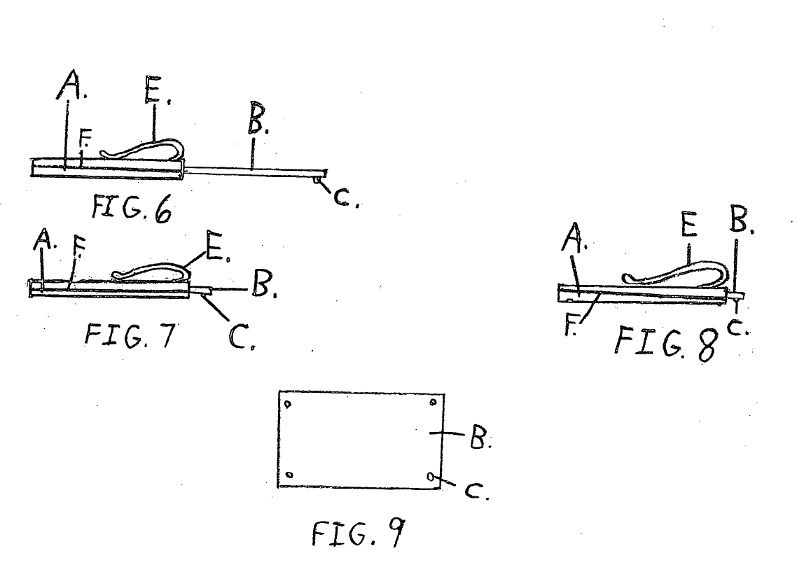

### DETAILED DESCRIPTION OF THE INVENTION

This invention is a removable, clip on, horizontal sun visor attachment for automobile sun visors. It consists basically of: a hard plastic outer shell, a solid plastic sliding visor extention which slides in and out of the outer shell with a set of small bumps on each end of the plastic visor prevent it from sliding too far in or out of the shell, two metal clips attatched to the back of the outer shell by rivets to enable the “Blind Me Not” to be clipped on to an existing automobile sun visor, and a mirror on the front face of the outer shell. Since many existing sun visors in automobiles are too short to completely cover the horizontal length of an automobile's window, the suns position can still cause a driver to be “blinded” by the sun depending on the suns location at certain times of the day, rendering a factory installed sun visor to be useless. Attaching the “Blind Me Not” to the existing sun visor and exetending it horizontally will prevent the driver and/or front passenger from being blinded and could prevent accidents. The “Blind Me Not” is removeable and may be used on both the driver's side and passenger side existing factory installed sun visor. It is compatible with most vehicles.

The outer shell will be made of two solid pieces of hard plastic fitted together to form one shell, thus creating a seam along the top, bottom, and two sides. The solid plastic horizontally sliding visor will be of one solid piece with a small rounded bump near each corner, one pair always visible to keep it slightly protruding when not extended, and one pair, not visible to keep the visor from being completely pulled out of the shell.

The two metal clips will be fastened to the back of the shell by metal or plastic rivets. The clips will enable the device to be attached to the existing automobile sun visor.

A mirror will be attached to the front face of the shell with epoxy.

1. What I claim as my invention is an attachable, horizontally sliding automobile sun visor extension.
